(19) United States
(12) Patent Application Publication
(10) Pub. No.: US 2017/0307366 A1
(43) Pub. Date: Oct. 26, 2017

(54) PROJECTION DEVICE, MEASURING APPARATUS, AND ARTICLE MANUFACTURING METHOD

(71) Applicant: CANON KABUSHIKI KAISHA, Tokyo (JP)

(72) Inventor: Takumi Tokimitsu, Utsunomiya-shi (JP)

(21) Appl. No.: 15/483,451

(22) Filed: Apr. 10, 2017

(30) Foreign Application Priority Data
Apr. 22, 2016 (JP) 2016-086149

(51) Int. Cl. G01B 11/25; G02B 27/09

(52) U.S. Cl. CPC G01B 11/2513; G02B 27/0927; G02B 27/0988

(57) ABSTRACT

Provided is a projection device that comprises a projection optical system for projecting periodic pattern light onto an object, the projection device having an aperture stop that is placed on a pupil plane of the projection optical system, wherein conditional expressions L₁/L₂>S₁/S₂ and L₁>S₁ are satisfied, where L₁ represents a dimension of the periodic pattern light in a periodic direction and L₂ represents a dimension in a direction vertical to the periodic direction, for an image intensity distribution of a light source, which is formed in the pupil plane by light emitted from the light source, and S₁ represents a dimension in the periodic direction of the periodic pattern light and S₂ represents a dimension in the direction vertical to the periodic direction, for an opening of the aperture stop.

### BACKGROUND OF THE INVENTION

### Field of the Invention

The present invention relates to a projection device, a measuring apparatus, and an article manufacturing method.

### Description of the Related Art

An optical measuring apparatus that uses a pattern projection method is known as an apparatus for measuring the shape of an object. The pattern projection method finds the shape of the object by projecting a predetermined pattern light onto the object, capturing an image of the object having the predetermined pattern projected thereon to obtain a captured image, detecting a pattern in the captured image, and calculating distance information in each pixel position according to the principle of triangulation.

A projection device (projector) included in the measuring apparatus performs projecting of the predetermined pattern light onto the object. In the projector, illuminating the object uniformly and efficiently utilizing light emitted from a light source is required. As one technology for improving light utilization efficiency, there is a technology for setting the shape of an image intensity distribution of a light source and the shape of an opening in an aperture stop to be similarly shaped (Japanese Patent No. 3182863 and Japanese Patent Laid-Open No. H08-313860).

However, with devices disclosed in Japanese Patent No. 3182863 and Japanese Patent Laid-Open No. H08-313860, placement errors of the light source and the aperture stop, which are included in the projector, and the like may cause the occurrence of a portion where an image of the light source has not been formed (a lack of a light intensity distribution in a pupil plane), in the opening of the aperture stop. The lack of the light intensity distribution in the pupil plane causes reduced illuminance uniformity in a pattern projection surface of the object, and thereby a detection error of the pattern light may occur. While a method is considered in which the opening of the aperture stop is set smaller in order to prevent the occurrence of the lack of the light intensity distribution in the pupil plane, this method decreases the light utilization efficiency.

### SUMMARY OF THE INVENTION

In view of the foregoing, the present invention provides, for example, a projection device which is advantageous in light utilization efficiency.

According to an aspect of the present invention, a projection device that comprises a projection optical system for projecting periodic pattern light onto an object is provided, wherein the projection device has an aperture stop that is placed on a pupil plane of the projection optical system, and conditional expressions L₁/L₂>S₁/S₂ and L₁>S₁ are satisfied, where L₁ represents a dimension of the periodic pattern light in a periodic direction and L₂ represents a dimension in a direction vertical to the periodic direction, for an image intensity distribution of a light source, which is formed in the pupil plane by light emitted from the light source, and S₁ represents a dimension in the periodic direction of the periodic pattern light and S₂ represents a dimension in the direction vertical to the periodic direction, for an opening of the aperture stop.

Further features of the present invention will become apparent from the following description of exemplary embodiments with reference to the attached drawings.

### BRIEF DESCRIPTION OF THE DRAWINGS

FIG. 1 is a perspective view illustrating a configuration of a measuring apparatus provided with a projection device according to a first embodiment.

FIG. 2 illustrates an example of dot line pattern light.

FIG. 3 illustrates the configuration of the projection device in detail.

FIGS. 4A to 4C illustrate relations between an opening of an aperture stop and an image intensity distribution of a light source that is formed on a pupil plane of a projection optical system.

FIGS. 5A and 5B illustrate point image distributions on a focus plane of the projection optical system and a plane in the vicinity of the focus plane.

FIGS. 6A and 6B illustrate relations between an opening of an aperture stop and an image intensity distribution of a light source that is formed on a pupil plane of a projection optical system according to the first embodiment.

FIGS. 7A and 7B illustrate relations between an opening of an aperture stop and an image intensity distribution of a light source that is formed on a pupil plane of a projection optical system according to a second embodiment.

FIG. 8 illustrates a control system provided with the measuring apparatus and a robot arm.

### DESCRIPTION OF THE EMBODIMENTS

Hereinafter, preferred embodiments of the present invention will be described with reference to the drawings.

### First Embodiment

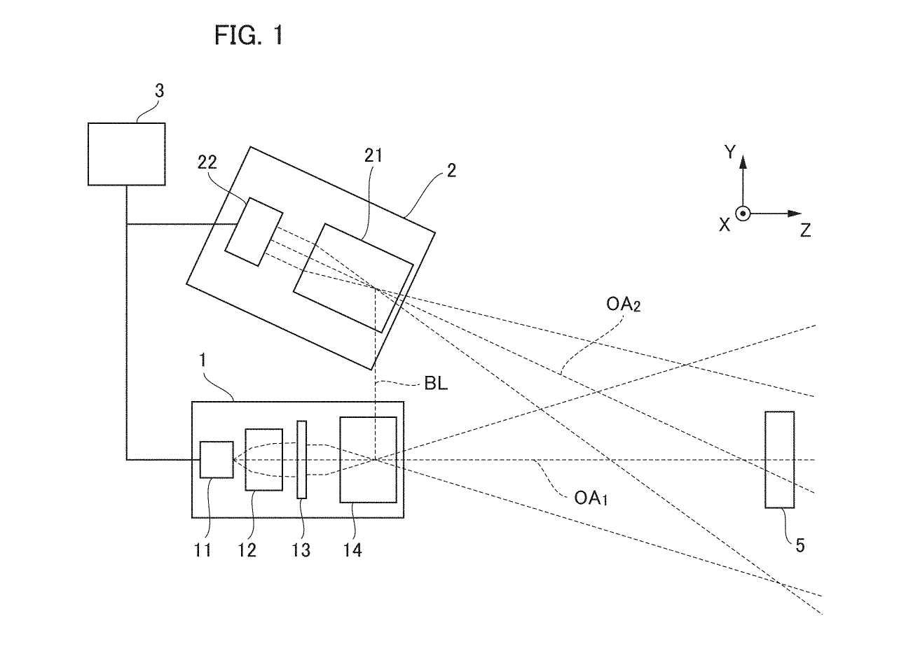

FIG. 1 is a perspective view illustrating a configuration of a measuring apparatus provided with a projection device according to a first embodiment of the present invention. The measuring apparatus measures the shape (for example, three dimensional shape, two dimensional shape, position and orientation, or the like) of an object to be measured 5 (object to be detected, or object) by using a pattern projection method. The measuring apparatus has a projection device (projector) 1, an imaging device (imaging unit) 2, and a processing unit 3, as shown in FIG. 1. In the drawings, mutually orthogonal axes X and Y are set as directions within a plane placed on the object to be measured 5, and a Z axis is set as a direction orthogonal to this X-Y plane.

The projection device 1 that includes, for example, a light source unit 11, an illumination optical system 12, a pattern generation unit 13, and a projection optical system 14, projects a predetermined pattern light onto the object to be measured 5. An optical axis of the projection device 1 is defined as an optical axis OA₁. As the light source unit 11, various light-emitting elements such as a halogen lamp and LED can be used. In the present embodiment, a surface-mounted type LED consisting of one chip is used to uniformly irradiate an entrance pupil of the projection optical system 14. In addition, the emitting unit of the light source unit 11 has a rectangle shape. The illumination optical system 12 forms a light source image of light emitted from the light source unit 11 onto the entrance pupil of the projection optical system 14, and then illuminates a pattern generated by the pattern generation unit 13 uniformly (for example, Koehler illumination).

The pattern generation unit 13 that generates pattern light to be projected onto the object to be measured 5 is, in the present embodiment, composed of a mask having a pattern formed thereon by chroming a glass substrate. However, the pattern generation unit 13 may also be composed of, for example, a digital light processing (DLP) projector, a liquid crystal projector, or the like, each of which is capable of generating an arbitrary pattern. The projection optical system 14 is an optical system that projects the pattern light generated by the pattern generation unit 13 onto the object to be measured 5.

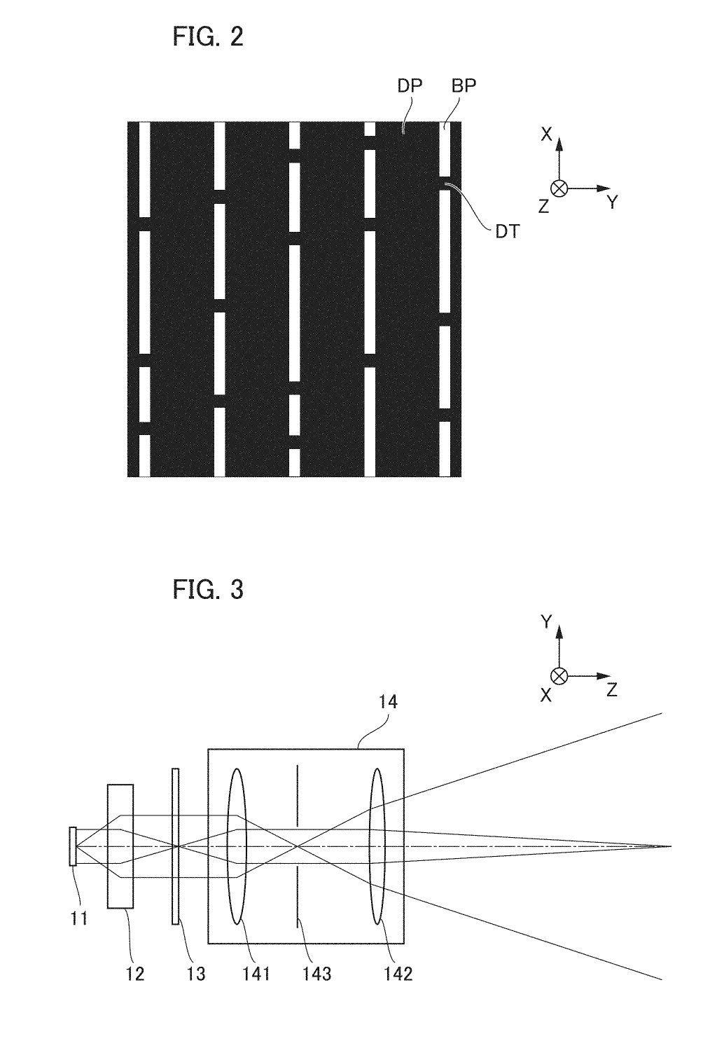

FIG. 2 illustrates dot line pattern light (periodic pattern light), which is an example of pattern light that is generated by the pattern generation unit 13 and is projected onto the object to be measured 5. The dot line pattern light is a periodic line pattern light (striped pattern light) that includes bright lines and dark lines alternately placed one by one in the Y-direction (periodic direction) of the drawing, in which each bright line includes bright portions BP and dots DT, and each dark line forms dark portion DP, as shown in FIG. 2. Each of the dots DT is placed at unequal intervals between a bright portion BP and another bright portion BP in such a way as to divide a bright line with respect to a direction (the x-direction orthogonal to the Y-direction) in which the bright portion BP extends on the bright line. The dots DT are identification portions used to identify individual bright lines. Since the positions of the dots DT varies with the respective bright lines, coordinate (position) information of the detected dots DT provides an index indicating to which line on the pattern generation unit 13 each projected bright line corresponds, thus enabling identifying each projected bright line.

Referring back to FIG. 1, the imaging device 2 which includes, for example, an imaging optical system 21, and an image sensor 22, captures an image of the object to be measured 5 to obtain an image. An optical axis of the imaging device 2 is defined as an optical axis OA₂. In the present embodiment, the imaging device 2 captures an image of the object to be measured 5 having the dot line pattern light projected thereon to obtain an image (distance image) that includes a portion corresponding to the dot line pattern light. The imaging optical system 21 is an image forming optical system for forming, on the image sensor 22, an image of the dot line pattern light projected onto the object to be measured 5. The image sensor 22, which is a sensor including a plurality of pixels used to capture an image of the object to be measured 5 having the pattern light projected thereon, is composed of, for example, a complementary metal-oxide semiconductor (CMOS) sensor, a charge-coupled device (CCD) sensor, or the like.

The projection device 1 and the imaging device 2 are placed such that the distance therebetween is the length (base line length) of a base line BL that intersects optical centers of the projection device 1 and the imaging device 2. Here, the optical center refers to a pupil position on the object-side of the optical system included in each of the projection device 1 and the imaging device 2. Moreover, in the present embodiments, a direction which bright portions BP and dark portions DP extend is set as a direction orthogonal to the base line BL.

The processing unit 3 finds the shape of the object to be measured 5 based on a pattern coordinate found from the captured image by the imaging device 2, optical properties of the projection device 1 and the imaging device 2, the base line length, and the like. The pattern coordinate is found based on, for example, a luminance distribution of a cross section in a direction (Y-direction) that intersects the bright portions BP for each pixel coordinate in a direction (X-direction) parallel to the bright portions BP, in the captured image. The present embodiment finds the pattern coordinate by identifying the bright portions BP from the positions of the dots DT detected with such a luminance distribution.

FIG. 3 illustrates the configuration of the projection device 1 in detail. The projection optical system 14 included in the projection device 1 has lenses 141 and 142, and an aperture stop 143. Lenses 141 and 142 are placed such that the aperture stop 143 is placed therebetween. In addition, the aperture stop 143 is placed in the pupil plane of the projection optical system 14.

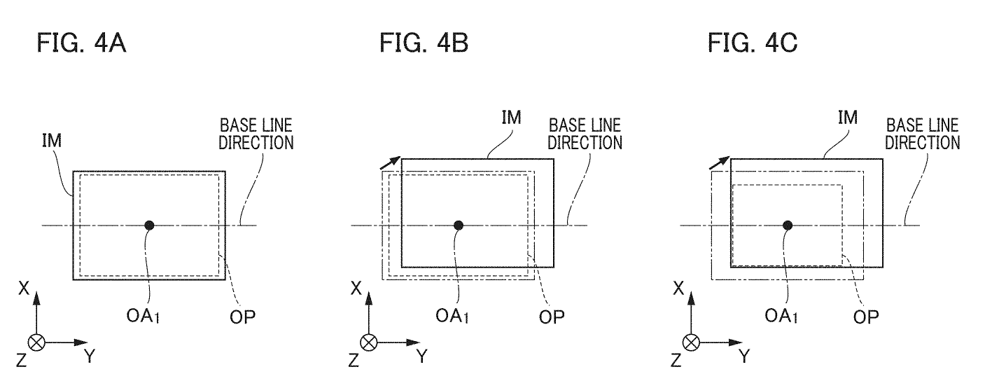

FIGS. 4A to 4C illustrate the relations between the opening of the aperture stop 143 and the image intensity distribution of the light source, which is formed on the pupil plane of the projection optical system 14. In FIG. 4A, a dashed line represents the opening OP and a solid line represents the image intensity distribution of the light source (light source image) IM. The light source image IM has a shape substantially coincident with the opening OP, and is generally formed in the opening OP (the pupil plane of the projection optical system 14). FIG. 4B illustrates the instance in which the position where the light source image IM is formed shifts in the opening OP due to placement errors and manufacturing errors of the light source unit 11, the aperture stop 143, or the like. In FIG. 4B, a two-dot dashed line represents the light source image IM prior to shift, a solid line represents the light source image IM after the shift, and an arrow represents the direction of the shift.

Here, the shift of the light source image IM occurs due to an angular error of the principal beam of the illumination optical system 12 and the principal beam of the projection optical system 14 under the placement errors as mentioned above. For example, in the case where the illumination optical system 12 is composed so as to be smaller, an angle property at the periphery of field angle is steeply varied, so that the shift easily occurs. While the error due to the shift includes a component which is generated evenly at the field angle due to the placement error of the light source unit 11 in X and Y directions, in the present embodiment, for the sake of simplification a description will be given of a component which is generated only at the periphery of the field angle due to the placement error of the light source unit 11 in the Z direction. Therefore, FIG. 4A shows the light source image IM which is formed by a light flux passed through the center of the field angle and where no shift occurs, and FIG. 4B shows the light source image IM which is formed by a light flux passed through the periphery of the field angle and where the shift occurs. In the following description with regard to the relation between the light source image and the opening as mentioned above, drawings in which the shift occurs such that the center of the light source image shifts from the optical axis OA₁ of the projection device 1 are also used as a light source image formed by a light flux passed through the periphery of the field angle.

Referring to FIG. 4B, it will be appreciated that a portion is generated in which the light source image IM is not formed in the opening OP by the shift of the light source image IM. The lack of the light intensity distribution in the opening OP may lead to reduction in the illuminance uniformity of pattern light projected onto the object to be measured 5. FIG. 4C illustrates the instance in which the shape of the opening OP is set to be smaller in order to eliminate the portion (the lack of the light intensity distribution) where the light source image IM is not formed. As shown in FIG. 4C, the lack of the light intensity distribution comes to be eliminated in the opening OP. However, the small opening OP reduces the size of the light source image IM covered by the opening OP to decrease the light utilization efficiency. In addition, in the case where the size of the emitting unit included in the light source unit 11 enlarges to improve the lack, the light utilization efficiency is decreased similarly, and the energy consumption and the calorific value of the light source unit 11 may increase in order to keep the illuminance on the object to be measured 5.

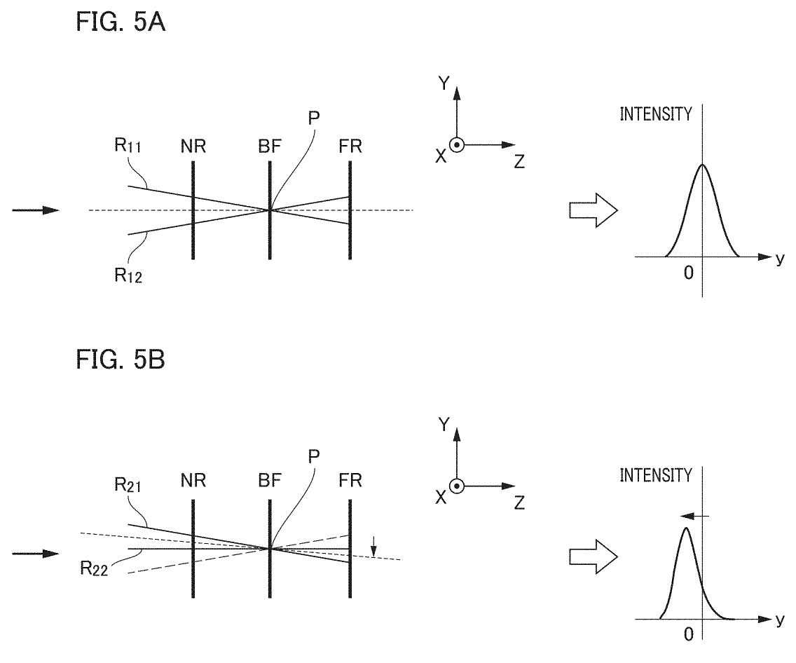

The lack of the light intensity distribution brings about a loss of the symmetry of a light orientation distribution (point image distribution) on the pattern projection surface of the object to be measured 5. FIGS. 5A and 5B illustrate point image distributions on a focus plane of the projection optical system 14 (projection device 1) and a plane in the vicinity of the focus plane. FIG. 5A is for the instance where there is no lack of the light intensity distribution, a plane BF is defined as the focus plane of the projection optical system 14, a plane NR is defined as a plane parallel to the focus plane and near to the projection optical system 14, and a plane FR is defined as a plane parallel to the focus plane and distant from the projection optical system 14, at a left side of FIG. 5A. The imaging device 2 can capture an image on any plane. Beams R₁₁ and R₁₂ are defined as the outermost peripheral beams in light flux passed through a point p on the plane BF from among the light irradiated from the projection device 1. In this instance, a point image distribution on the plane FR is shown in a right side of FIG. 5A. A lateral axis represents a position in the Y direction on the plane FR, an origin represents a position of the point p, and a longitudinal axis represents light intensity. If there is no lack of the light intensity distribution in the opening OP, the point image distribution becomes a symmetric distribution with respect to the position of the point p. Specifically, pattern light is projected with a uniform illuminance for all of the planes.

In contrast, FIG. 5B is for the instance where there is a lack of the light intensity distribution in the opening OP, and Beams R₂₁ and R₂₂ are defined as the outermost peripheral beams in light flux passed through the point p similar to the instance shown in FIG. 5A, from among the light irradiated from the projection device 1. In this instance, a point image distribution on the plane FR is shown in a right side of FIG. 5B. A lateral axis, an origin, and a longitudinal axis are defined in the same manner as FIG. 5A. If there is the lack of the light intensity distribution, the point image distribution becomes a non-symmetric distribution with respect to the position of the point p. Specifically, the center of gravity in the light flux shifts in the −Y direction on the plane FR, and the center of gravity in the light flux shifts in the +Y direction on the plane NR. This may lead to a reduction of illuminance uniformity in pattern projection (pattern detection error).

Note that it is very difficult to reduce the lack of the light intensity distribution by calibration of the projection device 1, as the pattern detection error depends on the position of the object to be measured 5 in the Z direction and errors occur at significantly the periphery of field angle, but not generally at the field angle.

Here, in the instance where the dot line pattern light as shown in FIG. 2 is projected onto the object to be measured 5, a pattern coordinate is found based on a luminance distribution in the Y direction (base line BL direction). Thus, a projected pattern distortion in the X direction rarely generates any detection error in the pattern coordinate. This is because the bright portions BP and the dark portions DP extend in the X direction (direction vertical to the base line BL), and thereby, the distortion of the point image distribution in the X direction does not generate any projected pattern distortion substantially. Therefore, the projection device for project line pattern light may allow the lack of the light intensity distribution in a direction vertical to the base line.

Note that in the case where a pattern with marks (dots) for mapping lines is used like the present embodiment, it is simply required to detect dots, and thus, for a projected pattern distortion in the X direction, accuracy at a level for detecting the lines is not required.

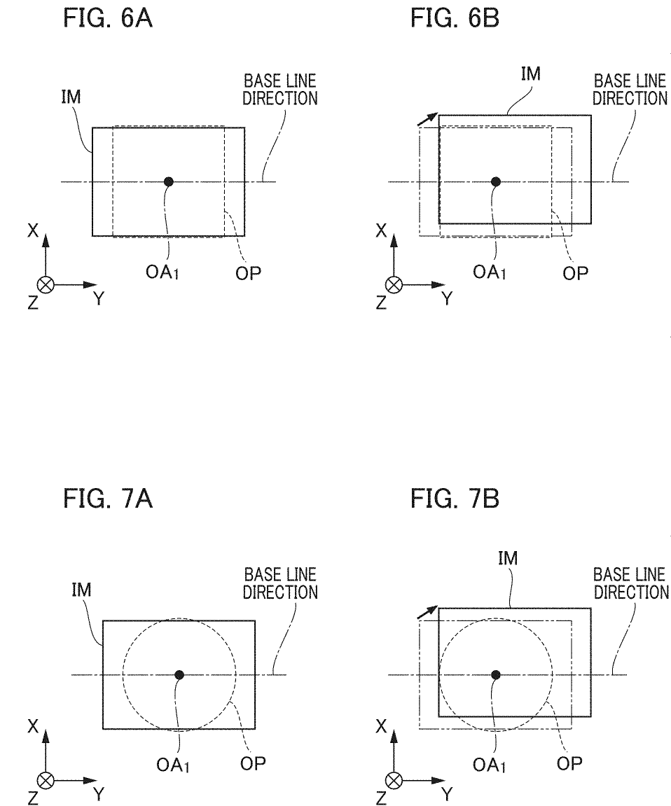

The projection device 1 of the present embodiment is configured so as to allow the lack of the light intensity distribution in a direction vertical to the base line at a level capable of detecting the dots, while reducing the occurrence of the lack of the light intensity distribution in the base line direction if the light source image is shifted due to an error on manufacturing and the like. FIGS. 6A and 6B illustrate the relations between the opening of the aperture stop and the image intensity distribution of the light source, which is formed on the pupil plane of the projection optical system 14 according to the present embodiment. FIG. 6A shows a relation before the shift occurs and FIG. 6B shows a relation after the shift occurs. The base line direction is indicated with a one-dot dashed line in the drawings thereof. The present embodiment employs the configuration in which the dimension of the light source image IM is larger than that of the opening OP in the base line direction, and the dimension of the light source image IM is equal to that of the opening OP in a direction vertical to the base line. This does not generate the lack of the light intensity distribution in the base line direction (Y direction), even if the light source image IM is shifted as shown in FIG. 6B. Here, a lack is generated in a level capable of detecting dots in the X direction. However, in the present embodiment, the lack in the X direction is allowed, and thereby the light utilization efficiency is improved.

Here, the mutual relation is represented by a conditional expression, where S₁ represents the dimension of the opening OP in the Y direction, L₁ represents the dimension of the light source image IM in the Y direction, S₂ represents the dimension of the opening OP in the X direction, and L₂ represents the dimension of the light source image IM in the X direction. The aforementioned dimensional relation between the light source image IM and the opening OP is represented by L₁>S₁ and L₂=S₂. Note that the dimension S₂ of the opening OP in the X direction may not be equal to the dimension L₂ of the light source image IM in the X direction, and a size relation does not matter because the lack in the X direction is allowed in a range capable of detecting the dots. In the present embodiment, the dots can be detected in a range in which L₂/S₂ is from 0.8 to 1.2, or more preferably from 0.9 to 1.1. In addition, with regard to the dimension S₁ of the opening OP in the Y direction, the dimension L₁ of the light source image IM in the Y direction is set as a dimension taking into consideration the light utilization efficiency. Therefore, it is preferable that L₁/S₁ is from 1.2 to 1.6, or it is more preferable that L₁/S₁ is from 1.3 to 1.5. Furthermore, an aspect ratio (i.e. L₁/L₂) of the shape of the light source image IM is set so as to be larger than an aspect ratio (i.e. S₁/S₂) of the shape of the opening OP from the point of view of reducing the lack in the base line direction (so that they are non-similar). Additionally, it is desirable that L₁/L₂ is larger than 1 (L1>L2).

The dimension of the light source image IM mentioned above can be confirmed by simulating or examining the light intensity distribution on the pupil plane, for example, in the case where a small transmission portion is arranged in a center position of the pattern generation unit 13.

Thus, the projection device comprising the configuration of the present embodiment can improve the illuminance uniformly on the pattern projected surface of the object to be measured, while suppressing the reduction in the light utilization efficiency. The measuring apparatus comprising this projection device can detects a projected pattern with a high accuracy. As disclosed above, according to the present embodiment, a projection device can be provided which is advantageous in light utilization efficiency.

### Second Embodiment

FIGS. 7A and 7B illustrate the relations between the opening of the aperture stop and the image intensity distribution of the light source, which is formed on the pupil plane of the projection optical system according to the present embodiment. Taking easy manufacture, easy placement in the projection optical system 14, placement accuracy and the like for the aperture stop 143 into consideration, the opening OP of the present embodiment has a circular shape. This can reduce the shift of the light source image IM. FIG. 7A shows a relation before the shift occurs and FIG. 7B shows a relation after the shift occurs. The present embodiment also employs the configuration in which the dimension of the light source image IM is larger than that of the opening OP in the base line direction, and the dimension of the light source image IM is equal to that of the opening OP in the direction orthogonal to the base line. Note that the relation similar to the first embodiment is satisfied preferably, where S₁ and S₂ represent the dimensions of the opening OP in the Y and X directions respectively, and L₁ and L₂ represent the dimensions of the light source image IM in the Y and X directions respectively. The same effect as that in the first embodiment may be provided by the projection device of the present embodiment.

Although the base line BL is orthogonal to the optical axis OA₁ of the projection device 1 in the aforementioned configuration, the base line direction may be considered as a direction where the base line is projected from the optical axis OA₁ of the projection device 1 to the pupil plane of the projection optical system 14, in a configuration in which they are not mutually orthogonal. Additionally, in order to reduce shape error and placement error of the opening OP, a fixed aperture with the fixed dimension of the opening OP is more suitable for the aperture stop 143 than a variable aperture with a dimension varying mechanism of the opening OP.

A pattern is not limited to the pattern shown in FIG. 2, which is generated by the pattern generation unit 13 and is projected on the object to be measured 5, and thus, a pattern in which the bright portions and the dark portions are reversed may be used. The pattern with a plurality of lines, such as a gradation pattern and a multi-color pattern may also be used. Lines may be straight or curved. Furthermore, the aforementioned embodiment is not limited to using lines as the pattern, and a random-dots pattern may be used. The identification portions located on the lines are not limited to the dots, and marks capable of identifying each line may be used (for example, circular portions or narrowed portions). Dots may be located on the bright portions or the dark portions.

### Third Embodiment

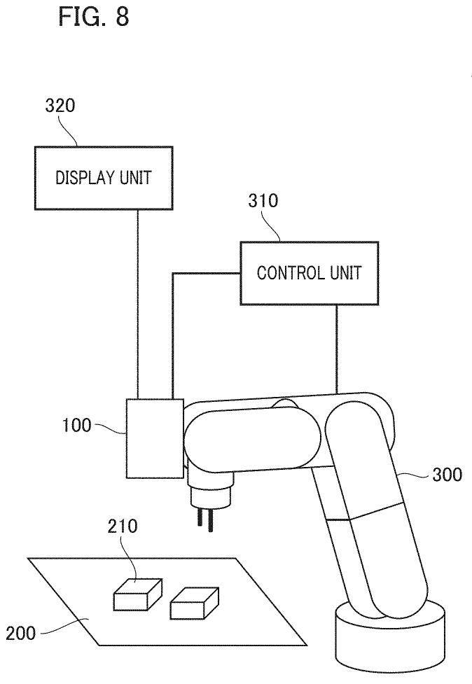

The aforementioned measuring apparatus may be used while being supported by any supporting member. In the present embodiment, a description will be given of an example of a control system that is used while equipped in a robot arm 300 (gripping device) as shown in FIG. 8. The measuring apparatus 100 projects a pattern light onto an object to be detected 210, which is located on supporting base 200, and captures an image of the object to be detected 210 to obtain the captured image. Sequentially, a control unit of the measuring apparatus 100 or a control unit 310 that has acquired image data from the control unit of the measuring apparatus 100 finds a position and an orientation of the object to be detected 210, and then the control unit 310 acquires information about the found position and orientation. The control unit 310 controls the robot arm 300 by sending a drive command to the robot arm 300 based on the information (measurement result) about their position and orientation. The robot arm 300 holds the object to be detected 210 with a robot hand (gripping unit) or the like which is located at the tip thereof to move the object to be detected 210 translationally, rotationally, or the like. Furthermore, an article composed of a plurality of parts, such as an electronic circuit substrate and machine can be manufactured by installing (assembling) the object to be detected 210 in another part by using the robot arm 300. In addition, an article can be manufactured by processing the moved object to be detected 210. The control unit 310 has a calculating unit such as a CPU and a storage unit such as a memory. Note that a display unit 320 (such as display) may display measurement data obtained by measurement with the measuring apparatus 100, the obtained image, or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-086149, filed Apr. 22, 2016, which is hereby incorporated by reference wherein in its entirety.

What is claimed is:

1. A projection device that comprises a projection optical system for projecting periodic pattern light onto an object, the projection device having:
an aperture stop that is placed on a pupil plane of the projection optical system,
wherein conditional expressions L₁/L₂>S₁/S₂ and L₁>S₁ are satisfied, where L₁ represents a dimension of the periodic pattern light in a periodic direction and L₂ represents a dimension in a direction vertical to the periodic direction, for an image intensity distribution of a light source, which is formed in the pupil plane by light emitted from the light source, and
S₁ represents a dimension in the periodic direction of the periodic pattern light and S₂ represents a dimension in the direction vertical to the periodic direction, for an opening of the aperture stop.

2. The projection device according to claim 1, wherein 1.2≦L₁/S₁≦1.6 is satisfied.

3. The projection device according to claim 2, wherein 1.3≦L₁/S₁≦1.5 is satisfied.

4. The projection device according to claim 1, wherein 0.8≦L₂/S₂≦1.2 is satisfied.

5. The projection device according to claim 4, wherein 0.9≦L₂/S₂≦1.1 is satisfied.

6. The projection device according to claim 1, wherein L₁>L₂ is satisfied.

7. The projection device according to claim 1, including a pattern generating unit that generates the periodic pattern by the light emitted from the light source,
wherein the periodic pattern passes through the opening and is projected onto the object.

8. A measuring apparatus having:
a projection device that comprises a projection optical system for projecting periodic pattern light onto an object; and
an imaging device that images the object onto which the periodic pattern light is projected by the projection device,
wherein the projection device has an aperture stop that is placed on a pupil plane of the projection optical system, and
conditional expressions L₁/L₂>S₁/S₂ and L₁>S₁ are satisfied, where L₁ represents a dimension of the periodic pattern light in a periodic direction and L₂ represents a dimension in a direction vertical to the periodic direction, for an image intensity distribution of a light source, which is formed in the pupil plane by light emitted from the light source, and
S₁ represents a dimension in the periodic direction of the periodic pattern light and S₂ represents a dimension in the direction vertical to the periodic direction, for an opening of the aperture stop.

9. A measuring apparatus having:
a projection device that comprises a projection optical system for projecting pattern light onto an object; and
an imaging device that images the object onto which the pattern light is projected by the projection device,
wherein the projection device has an aperture stop that is placed on a pupil plane of the projection optical system, and
conditional expressions L₁/L₂>S₁/S₂ and L₁>S₁ are satisfied, where L₁ represents a dimension in a base line direction that intersects the projection device and the imaging device and L₂ represents a dimension in a direction vertical to the base line direction, for an image intensity distribution of a light source, which is formed in the pupil plane by light emitted from the light source, and
S₁ represents a dimension in the base line direction and S₂ represents a dimension in the direction vertical to the base line direction, for an opening of the aperture stop.

10. The measuring apparatus according to claim 9, wherein the pattern light is a periodic pattern light, and
the projection device and the imaging device are placed so as to match the base line direction with a periodic direction of the periodic pattern light.

11. A system having a measurement apparatus for measuring an object and a robot for holding and moving the object based on measurement result by the measurement apparatus,
wherein the measuring apparatus has:
a projection device that comprises a projection optical system for projecting pattern light onto the object; and
an imaging device that images the object onto which the pattern light is projected by the projection device, and
the projection device has an aperture stop that is placed on a pupil plane of the projection optical system, and
conditional expressions L₁/L₂>S₁/S₂ and L₁>S₁ are satisfied, where L₁ represents a dimension of the periodic pattern light in a periodic direction and L₂ represents a dimension in a direction vertical to the periodic direction, for an image intensity distribution of a light source, which is formed in the pupil plane by light emitted from the light source, and
S₁ represents a dimension in the periodic direction of the periodic pattern light and S₂ represents a dimension in the direction vertical to the periodic direction, for an opening of the aperture stop.

12. A system having a measurement apparatus for measuring an object and a robot for holding and moving the object based on measurement result by the measurement apparatus,
wherein the measuring apparatus has:
a projection device that comprises a projection optical system for projecting pattern light onto the object; and
an imaging device that images the object onto which the pattern light is projected by the projection device, and
the projection device has an aperture stop that is placed on a pupil plane of the projection optical system, and
conditional expressions L₁/L₂>S₁/S₂ and L₁>S₁ are satisfied, where L₁ represents a dimension in a base line direction that intersects the projection device and the imaging device and L₂ represents a dimension in a direction vertical to the base line direction, for an image intensity distribution of a light source, which is formed in the pupil plane by light emitted from the light source, and
S₁ represents a dimension in the base line direction and S₂ represents a dimension in the direction vertical to the base line direction, for an opening of the aperture stop.

13. A method for manufacturing an article, the method comprising:
measuring an object by using a measuring apparatus; and
manufacturing the article by processing the object based on measurement result,
wherein the measuring apparatus has:
a projection device that comprises a projection optical system for projecting pattern light onto the object; and
an imaging device that images the object onto which the pattern light is projected by the projection device, and the projection device has an aperture stop that is placed on a pupil plane of the projection optical system, and
conditional expressions L₁/L₂>S₁/S₂ and L₁>S₁ are satisfied, where L₁ represents a dimension of the periodic pattern light in a periodic direction and L₂ represents a dimension in a direction vertical to the periodic direction, for an image intensity distribution of a light source, which is formed in the pupil plane by light emitted from the light source, and
S₁ represents a dimension in the periodic direction of the periodic pattern light and S₂ represents a dimension in the direction vertical to the periodic direction, for an opening of the aperture stop.

14. A method for manufacturing an article, the method comprising:
measuring an object by using a measuring apparatus; and
manufacturing the article by processing the object based on measurement result,
wherein the measuring apparatus has:
a projection device that comprises a projection optical system for projecting pattern light onto the object; and
an imaging device that images the object onto which the pattern light is projected by the projection device, and
the projection device has an aperture stop that is placed on a pupil plane of the projection optical system, and
conditional expressions L₁/L₂>S₁/S₂ and L₁>S₁ are satisfied, where L₁ represents a dimension in a base line direction that intersects the projection device and the imaging device and L₂ represents a dimension in a direction vertical to the base line direction, for an image intensity distribution of a light source, which is formed in the pupil plane by light emitted from the light source, and
S₁ represents a dimension in the base line direction and S₂ represents a dimension in the direction vertical to the base line direction, for an opening of the aperture stop.
